(19) United States
(12) Patent Application Publication
(10) Pub. No.: US 2015/0254776 A1
(43) Pub. Date: Sep. 10, 2015

(54) SHAREHOLDER-ADVISED CORPORATE GOVERNANCE

(71) Applicant: FMR LLC, Boston, MA (US)

(72) Inventor: Ronald Raikula, Boston, MA (US)

(73) Assignee: FMR LLC, Boston, MA (US)

(21) Appl. No.: 14/197,375

(22) Filed: Mar. 5, 2014

(51) Int. Cl. G06Q 40/06; G06Q 10/06

(52) U.S. Cl. CPC G06Q 40/06; G06Q 10/0637

(57) ABSTRACT

A shareholder advised corporate governance (SACG) platform is provided that includes a data store that stores all relevant corporate information regarding a corporate entity. A number of services use the corporate information to expose corporate governance issues to shareholders or aggregates allowing the shareholder and aggregates to assess board actions by the corporate entity.

### BACKGROUND OF THE INVENTION

The invention related to the field of corporate governance, and in particular to a platform for collecting Mutual Fund or Exchange Traded Fund (ETF) shareholder input on corporate governance issues.

The common definition of corporate governance most widely used is the system by which companies are directed and controlled. More specifically it is the framework by which the various stakeholder interests are balanced, or, as the IFC states, the relationships among the management, Board of Directors, controlling shareholders, minority shareholders and other stakeholders.

While the conventional definition of corporate governance acknowledges the existence and importance of other stakeholders they still focus on the traditional debate on the relationship between disconnected owners (shareholders) and often self-serving managers. While Corporations have a direct connection with individuals or institutions who own their shares, they have no knowledge of, nor communication with, the shareholders in mutual funds or ETFs that invest in their company. The individuals who own mutual funds or ETFs have no ability to participate in corporate governance, even though it is largely their money, not the Fund Manager's, that is invested in a given company. That ownership is indirect through the vehicle of the mutual fund or ETF.

Presently, there is no tool that can aid fund managers in better assessing fund or ETF shareholder interests when executing their fiduciary responsibility to vote the mutual fund or ETF's aggregate position as part of corporate governance.

### SUMMARY OF THE INVENTION

According to one aspect of the invention, there is provided a shareholder advised corporate governance (SACG) platform. The SACG includes a data store that stores all relevant corporate information regarding a corporate entity. A number of services use the corporate information to expose corporate governance issues to shareholders or aggregates allowing the shareholder and aggregates to assess board actions by the corporate entity.

According to another aspect of the invention, there is provided a computer-implemented method of assessing corporate governance issues of a corporate entity. The method includes providing a data store that stores all relevant corporate information regarding the corporate entity. Moreover, the method includes executing a plurality of services on a computing device that use the corporate information to expose corporate governance issues to shareholders or aggregates allowing the shareholder and aggregates to assess board actions by the corporate entity.

According to another aspect of the invention, there is provided a computer program product, disposed on a non-transitory computer readable storage medium, for assessing corporate governance issues of a corporate entity. The computer program product includes instructions for causing a processor to provide a data store that stores all relevant corporate information regarding the corporate entity. A number of services are executed on a computer system that use the corporate information to expose corporate governance issues to shareholders or aggregates allowing the shareholder and aggregates to assess board actions by the corporate entity.

### BRIEF DESCRIPTION OF THE DRAWINGS

FIG. 1 is a schematic diagram illustrating the platform used in accordance with the invention; and

FIG. 2 is a schematic diagram illustrating the process of the match interests & holding service.

### DETAILED DESCRIPTION OF THE INVENTION

The invention involves a Shareholder Advised Governance platform that exposes corporate governance issues to shareholders and aggregates participating shareholder positions for trustee action. Direct ownership of company stock grants shareholder rights to investors. As a shareholder in a public company, the investor gains a voice in company governance proportional to their share ownership. When an investor owns a mutual fund or ETF, their share ownership in company stock is indirect. The company shares comprising the mutual fund or ETF are held in the name of the mutual fund or ETF. Any shareholder rights to vote on corporate governance issues (or submit them) are exercised by the mutual fund or ETF and are voted by the fund's trustees. The invention aids fund managers and corporate heads in better determining any governance issues to communicate to shareholders and aggregates participating shareholder positions for trustee action.

Corporate governance refers to the system by which corporations are directed and controlled. The governance structure specifies the distribution of rights and responsibilities among different participants in the corporation (such as the board of directors, managers, shareholders, creditors, auditors, regulators, and other stakeholders) and specifies the rules and procedures for making decisions in corporate affairs. Governance provides the structure through which corporations set and pursue their objectives, while reflecting the context of the social, regulatory and market environment. Governance is a mechanism for monitoring the actions, policies and decisions of corporations. Governance involves the alignment of interests among the stakeholders.

The invention is a platform for which fund managers or even investors can determine and assess the implications of governance actions on the board. The invention leverages a plurality of stored information about a company and past director actions to evaluate the governance actions by the board. Any shareholder rights to vote on corporate governance issues (or submit new issues) are exercised by the mutual fund or ETF and are voted by the fund's trustees. This platform gathers shareholder opinions on governance issues and uses them to inform fund or ETF trustees or managers when operating on behalf of the shareholders.

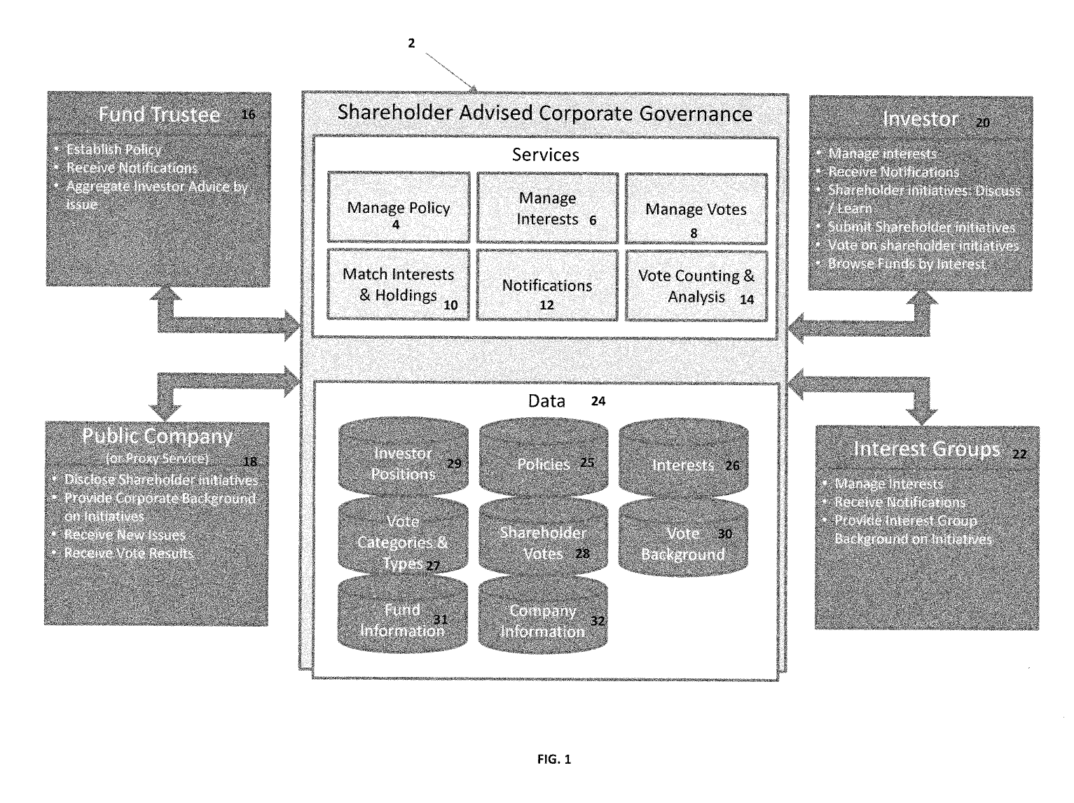

FIG. 1 shows a schematic diagram illustrating the Shareholder Advised Corporate Governance (SACG) platform 2 used in accordance with the invention. The SACG platform 2 includes a number of services, such the managing policy service 4, manage interests service 6, manage votes service 8, match interests & holdings service 10, notifications service 12, and vote counting & analysis service 14. A number of stakeholders interact with the SACG platform 2 that includes Fund Trustees 16, public companies 18, investors 20, and interest groups 22. Moreover, the SACG platform 2 stores and retrieves data using a data store 24. The data store 24 includes a number of databases that keep and catalog relevant information regarding issues of governance. The data store includes an investor position database 29, a policies database 25, interests database 26, vote categories & types database 27, shareholder votes database 28, vote background database 30, funds information database 31, and company information database 32. These databases can be stored on a remote server or local server the SAGC platform 2 is executing on.

The Fund Trustee 16 interacts with the manage policy service 4 to establish policies and these policies are stored in the policies database 25. Moreover, the Fund Trustee 16 receives notifications from the notifications service 12 concerning updates of any kind regarding a company of interests. The SAGC platform 2 also aggregates investor advice by issue.

A public company 18 interacts with the manage interests service 6 to disclose shareholder initiatives and stores the information in the interests database for later retrieval and analysis. Moreover, the public company 18 can also provide their respective background information on their respective initiatives to the managed interest service 6. The managed interests service 6 could store this information in the company information database 32. Third parties may act on behalf of public companies to provide or disclose this information indirectly.

The investor 20 can interact with the manage interests service 6 to manage their particular interests and stored that information in the interests database 26. Moreover, the notifications service 12 provides the investors of any notifications it has received. The managed votes service 8 would submit shareholder initiatives provided by the investor and store the information in either vote background database 30, shareholder votes database 28, or votes categories & types database 27. The manage votes service 8 and the vote counting & analysis service 14 would manage a vote of shareholder initiatives provided by the investor 20. These services would store the results in the shareholder votes database 28 or the vote categories & types database 27 for later analysis and retrieval. The match interests & holding service could also be used by an investor to determine funds or ETFs they want to browse or to make decisions on whether to invest in the fund or ETF.

Interest groups can also use the SACG platform as well as to assess company interests. In particular, interest groups could register with the SACG platform and use the manage interests service to better manage their interests. Moreover, interest groups receive notifications via the notifications service as well as background information from the match interests & holdings service.

The SACG platform 2 exposes corporate governance issues to shareholders and aggregates participating shareholder positions for trustee action/affirmation depending on policy & rules established by fund trustees. Additionally, the invention includes providing a social and discussion section made available to the general public. This could provide a general forum for corporate governance questions, votes, and issues to be discussed. The platform does not need to operate on all funds or ETFs equally. The SACG platform 2 captures shareholder wishes on corporate governance for existing issues sourced from companies or their proxy managers or new issues from shareholders to submit to companies. Moreover, the SACG platform 2 executes fund rights during proxy votes based on shareholder wishes, either pro-rata or winner-take-all. Search, subscription, and notification services match shareholder interests to corporate governance topics, including determining which funds or ETFs have the greatest number of issues matching shareholder interests. The SACG platform provides a collaborative education and discussion environment around governance topics, with information supplied by advocates of each side in a topic; for example, the corporate board view and one or more other advocate views.

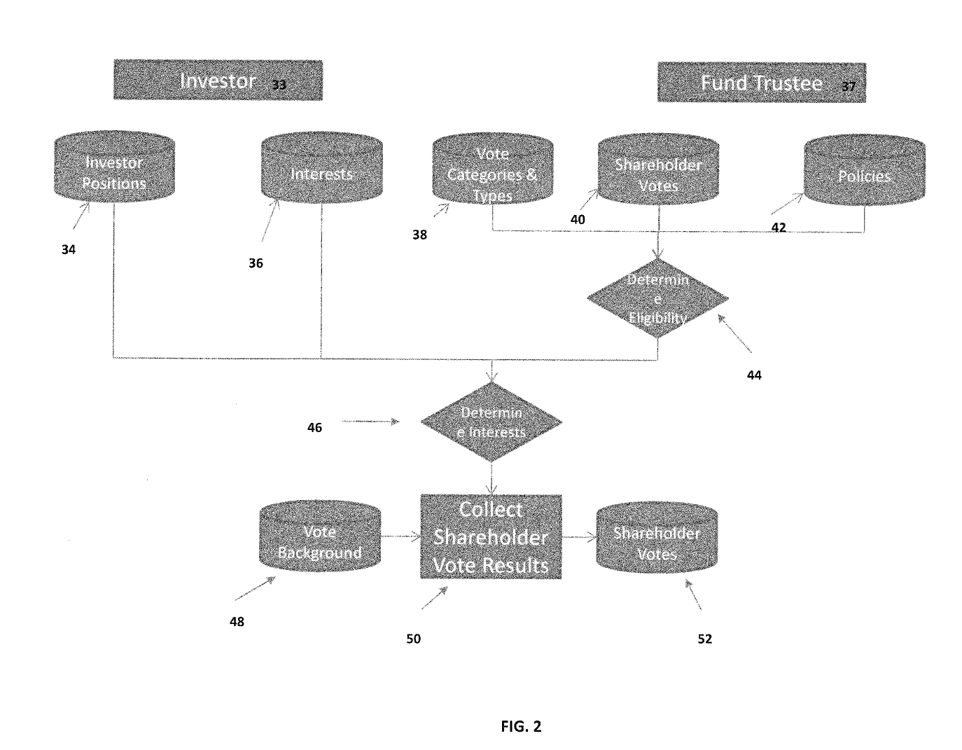

FIG. 2 is a schematic diagram illustrating the process of the match interests & holdings service. The match interests & holdings service performs a series of steps. With respect to investor, the match interests & holdings service accesses information about the investor's position via the investor 33 positions database, as shown step 34, as well as accessing information about the investor's interests from the interest database, as shown in step 36. With respect to a fund trustee 37, the match interests & holding service accesses information about a fund's vote categories and types via the vote categories and types database, as shown in step 38. Moreover, shareholder vote information of the fund or ETF and is accessed via the shareholder votes database, as shown in step 40, as well as the fund or ETF's policies via the policies database, as shown in step 42. Based on this information, a determination is made if the fund trustee has determined that shareholders are eligible to participate in any specific corporate governance question, as shown in step 44. If not, the platform will limit participation to discussion.

Once all information is collected about either the investor or fund manager, the match interests & holding service determines the interests by accessing the interests database, as shown in step 46. Moreover, the match interests & holding service accesses the votes background database, as shown in step 48, and collects shareholder vote results, as shown in step 50. The vote results are stored by the match interests & holding service in the shareholder votes database for later retrieval, as shown in step 52.

All software programs and system applications described herein are platform independent and can execute in any browser such as Firefox®, Internet Explorer®, or Chrome®. The web applicant can also be written in any platform independent-based computer language, such as Java or the like. All software programs and system applications execute on a client computer using a processor or the like. All software programs and system applications can be stored in the RAM or ROM of the client. Furthermore, all software programs and system applications can be stored on an external memory device to be uploaded to the client computer for execution. The elements associated with all software programs and system applications can be executed from the client computer or on a remote server. All database servers can be local on the client computer or on a remote server, as well as on a system remote from either the client computer or remote server. The client computer, remote server, and database servers communicate to each other using known communication protocols, such as TCP/IP.

Although the present invention has been shown and described with respect to several preferred embodiments thereof, various changes, omissions and additions to the form and detail thereof, may be made therein, without departing from the spirit and scope of the invention.

What is claimed is:

1. A shareholder advised corporate governance (SACG) platform executing on one of the processors of a network comprising:
a data store executing on one of a plurality of processors of the network that stores all relevant corporate information regarding a corporate entity and governance issues, wherein the relevant corporate information is provided by one or select entities with knowledge regarding the corporate entity's governance; and
a plurality of services executing on one of the processors of the network that use the corporate information to expose corporate governance issues to stakeholders or aggregates allowing the stakeholders or aggregates to assess board actions by the corporate entity, wherein the services use the relevant corporate information to assess each stakeholder's interested involvement in a corporate governance issue by accessing a plurality of databases.

2. The SACG of claim 1, wherein the services comprises a manage policy service that manages policies received by parties of interest.

3. The SACG of claim 1, wherein the services comprises a manage interests service that manages the interests of parties associated with the corporate entity.

4. The SACG of claim 1, wherein the services comprise a manage votes service that manages votes received by the shareholders or aggregates on shareholder initiatives.

5. The SACG of claim 1, wherein the services comprise a match interests & holdings service that matches the interests of a party to a corporate governance topic.

6. The SACG of claim 1, wherein the services comprise a notifications service that provides notification to a party regarding a governance topic.

7. The SACG of claim 1, wherein the services comprise a vote counting & analysis service that counts and analyzes votes regarding a stakeholder initiative.

8. The SACG of claim 1, wherein the stakeholders or aggregates comprise fund trustee, investor, public company, and interests groups.

9. A computer-implemented method of assessing corporate governance issues of a corporate entity comprising:
providing a data store that stores all relevant corporate information regarding the corporate entity, wherein the relevant corporate information is provided by one or select entities with knowledge regarding the corporate entity's governance; and
executing a plurality of services on a computing device that use the corporate information to expose corporate governance issues to stakeholders or aggregates allowing the stakeholders or aggregates to assess board actions by the corporate entity, wherein the services use the relevant corporate information to assess each stakeholder's interested involvement in a corporate governance issue by accessing a plurality of databases.

10. The computer implemented method of claim 9, wherein the services comprise a manage policy service that manages policies received by parties of interests.

11. The computer implemented method of claim 9, wherein the services comprise a manage interests service that manages the interests of parties associated with the corporate entity.

12. The computer implemented method of claim 9, wherein the services comprise a manage votes service that manages votes received by the stakeholders or aggregates on stakeholder initiatives.

13. The computer implemented method of claim 9, wherein the services comprise a match interests & holdings service that matches the interests of a party to a corporate governance topic.

14. The computer implemented method of claim 9, wherein the services comprise a notifications service that provides notification to a party regarding a governance topic.

15. The computer implemented method of claim 9, wherein the services comprise a vote counting & analysis service that counts and analyzes votes regarding a stakeholder initiative.

16. The computer implemented method of claim 9, wherein the stakeholders or aggregates comprise fund trustee, investor, public company, and interests groups.

17. A computer program product, disposed on a non-transitory computer readable storage medium, for assessing corporate governance issues of a corporate entity, the computer program product including instructions for causing a processor to
provide a data store that stores all relevant corporate information regarding the corporate entity, wherein the relevant corporate information is provided by one or select entities with knowledge regarding the corporate entity's governance; and
execute a plurality of services on a computer system that use the corporate information to expose corporate governance issues to stakeholders or aggregates allowing the stakeholders or aggregates to assess board actions by the corporate entity, the services use the relevant corporate information to assess each stakeholder's interested involvement in a corporate governance issue by accessing a plurality of databases.

18. The computer implemented method of claim 9, wherein the services comprise a manage policy service that manages policies received by parties of interests.

19. The computer implemented method of claim 9, wherein the services comprise a manage interests service that manages the interests of parties associated with the corporate entity.

20. The computer product of claim 17, wherein the services comprise a manage votes service that manages votes received by the stakeholders or aggregates on stakeholder initiatives.

21. The computer product of claim 17, wherein the services comprise a match interests & holdings service that matches the interests of a party to a corporate governance topic.

22. The computer product of claim 17, wherein the services comprise a notifications service that provides notification to a party regarding a governance topic.

23. The computer product of claim 17, wherein the services comprise a vote counting & analysis service that counts and analyzes votes regarding a stakeholder initiative.

24. The computer product of claim 17, wherein the stakeholders or aggregates comprise fund trustee, investor, public company, and interests groups.
